(19) United States
(12) Patent Application Publication
(10) Pub. No.: US 2005/0129821 A1
(43) Pub. Date: Jun. 16, 2005

(54) Unproofed frozen dough compositions and methods

(75) Inventors: Douglas L. Goedeken, Blaine, MN (US); Dennis A. Lonergan, Medina, MN (US); RoseBud L. Sierzant, Minneapolis, MN (US)

Correspondence Address: Daniel C. Schulte;Kagan Binder, PLLC, Maple Island Building, Suite 200, 221 Main Street North, Stillwater, MN, 55082, US

(73) Assignee: The Pillsbury Company

(21) Appl. No.: 10/733,065

(22) Filed: Dec. 11, 2003

(51) Int. Cl. A21D 10/00

(52) U.S. Cl. 426/549

(57) ABSTRACT

Described are dough compositions and methods of preparing them, including preferred compositions that can be unproofed and frozen, that can be baked from frozen, and that include yeast and chemical leavening agents. Preferred dough compositions can be prepared by methods that involve a resting step after mixing, freezing without proofing, and baking from frozen without proofing or thawing.

### FIELD OF THE INVENTION

The invention relates to unproofed frozen dough compositions and related methods and products.

### BACKGROUND

Commercial and consumer users of dough products appreciate the advantages associated with freezer-to-oven dough products. A freezer-to-oven (FTO) dough is one that can be stored at or below freezing (i.e., below about 32 F) and can be baked from the frozen state without thawing or proofing. Different varieties of FTO dough products exist, some being leavened with yeast and pre-proofed before frozen storage, and others being chemically leavened during baking. Some freezer-to-oven doughs use special ingredients such as added gluten, gums, and gelatin, or special processing, to provide stability and useful frozen storage properties to FTO doughs. Other FTO dough compositions use modified-atmosphere packaging, which may include a sealed atmosphere containing a high concentration of carbon dioxide or nitrogen. Examples of some of these different types of dough compositions are described in patent documents. See, e.g.,: U.S. Pat. No. 5,560,946 (using emulsifier and protein); U.S. Pat. No. 5,447,738 (using gums and gelatin); U.S. Pat. No. 5,254,351 (using gelatin optionally with gluten); U.S. Pat. No. 4,966,778 (using added protein); U.S. Pat. No. 4,406,911 (using hydrophilic colloids); U.S. Pat. No. 4,450,177 (using hydrophilic colloids, film-forming proteins, and surfactants). See also Assignee's copending U.S. patent application Ser. No. 09/877,937, Publication number 2003-0104100.

Further improvements in freezer-to-oven dough products are desirable in the dough products arts, including new compositions and methods of making FTO doughs. In particular, it would be desirable to eliminate burdensome manufacturing and storage processes or steps such as those relating to modified-atmosphere packaging, or steps of proofing a dough composition before freezing. It can also be desirable to provide dough compositions with improved oven spring as exhibited by baked specific volume.

### SUMMARY OF THE INVENTION

The invention relates to dough compositions and related methods, wherein the dough composition is not proofed prior to packaging or frozen storage, and can be baked from frozen storage without a thawing or proofing step. According to the invention, such a composition can be prepared from ingredients that include a chemical leavening system, as well as yeast that may assist in leavening the dough composition.

Dough compositions of the invention can be prepared by methods that include mixing dough ingredients followed by a step of resting the dough composition. A resting step as described herein can allow a dough composition to form bubbles, or can allow for bubbles previously formed in a dough composition to expand. Either can occur during a rest step by action of yeast, by action of chemical leavening agents, or by a combined action of both yeast and chemical leavening agents. The rest step, to allow the bubbles to form or expand, can increase the amount of leavening that occurs during baking (as compared to a dough that is not rested). It has been found that a useful amount of time for a resting step following mixing can be less than 30 minutes, e.g., from 5 to 30 minutes or from 10 to 20 minutes. Considered in terms of raw specific volume, a preferred rest step for an unproofed freezer-to-oven dough composition, can allow the dough composition to increase in raw specific volume to a raw specific volume greater than 1 cubic centimeter per gram and below 1.3 cubic centimeter per gram (cc/g), e.g., a raw specific volume in the range from 1 to 1.2 cc/g, prior to freezing. The rested dough composition can be processed as desired, including by steps to form a dough piece, and packaging, and is then frozen at the specified raw specific volume.

The frozen dough composition experiences additional leavening during baking. Leavening during baking can be caused by leavening action of the yeast, action of the chemical leavening system, or both. With the combination of a chemical leavening system and yeast as ingredients, combined with the rest step to form or enlarge bubbles and achieve the desired raw specific volume prior to freezing, frozen dough compositions according to the invention can be baked from frozen without a thawing or proofing step. Most preferably, according to the invention, inventive baked dough products can achieve a desirable baked specific volume, preferably greater than 2.8 cc/g, more preferably greater than 2.9 cc/g, e.g., from 3 to 4 cc/g.

The inventive dough compositions can be prepared and cooked (e.g., baked or fried) using various dough making techniques, without a proofing step prior to freezing, and without a proofing or a thawing step between frozen storage and baking. According to one preferred embodiment, a dough composition can be prepared by mixing dough ingredients; followed by a rest step after mixing and prior to further processing such as sheeting or dividing and rounding; then freezing the dough composition; then packaging the frozen dough composition. The frozen dough composition can be cooked (e.g., baked) without thawing or proofing. Dough compositions of the invention can be packaged in packaging materials that do not include provisions for maintaining the dough composition in a modified atmosphere. Thus, embodiments of the dough compositions do not require modified atmosphere packaging, and can still exhibit useful or improved baked specific volume and stability properties.

Also, in contrast to some other freezer-to-oven dough compositions, the inventive dough compositions do not require a high concentration of gluten, e.g., vital wheat gluten or an added source of concentrated wheat gluten. Nor do they require inclusion of special surfactants, special emulsifiers, or special hydrophilic colloids, like some other FTO dough compositions. Preferred dough compositions according to the invention also do not require special packaging to produce unproofed freezer-to-oven properties, such as modified atmosphere packaging, making the inventive dough compositions economical and practical.

The invention may be applied to a broad range of dough products ranging from sweet rolls to bread doughs to any other yeast-leavened finished dough products such as breads (pan bread, bread rolls, baguettes, dinner rolls), pizza crust, sweet rolls, donuts, or pastries, etc.

As used in the present description, weight percent ranges are in Baker's percent (percent on flour) where specifically noted to be, and are in weight percent of total dough composition including flour where not specifically noted to be in Baker's percent.

An aspect of the invention relates to a method of preparing a dough composition. The method includes providing a dough composition comprising flour, water, chemical leavening agent, and yeast as a leavening agent, resting the dough composition for a period sufficient to improve the baked specific volume of the dough composition upon baking, and freezing the dough composition without proofing. The dough composition can be baked from frozen, without thawing or proofing, to a baked specific volume of at least about 2.8 cubic centimeters per gram.

In another aspect, the invention relates to a method of preparing a dough composition. The method includes mixing ingredients into a dough composition including flour, yeast, water, acidic chemical leavening agent, and less than 2.5 parts by weight basic chemical leavening agent based in 100 parts by weight flour, resting the dough composition for at least five minutes, freezing the dough composition without a proofing step, storing the frozen dough composition, and baking the frozen dough composition, without thawing or proofing, to a baked specific volume of at least about 2.8 cubic centimeters per gram.

In another aspect, the invention relates to a method of preparing a dough composition. The method includes mixing ingredients into a dough composition including flour, yeast, water, acidic chemical leavening agent, and basic chemical leavening agent, resting the dough composition to produce a raw specific volume in the range from about 1.0 to about 1.3 cubic centimeters per gram, freezing the dough composition having a raw specific volume of from 1.0 to 1.3 cubic centimeters per gram, and baking the frozen dough composition, without thawing or proofing, to a baked specific volume of at least about 2.8 cubic centimeters per gram.

In yet another aspect, the invention relates to a frozen, unproofed dough composition that includes flour, water, yeast, chemical leavening agent comprising greater than zero and less than 2.5 parts by weight basic chemical leavening agent based on 100 parts by weight flour, and acidic chemical leavening agent. The dough composition can be baked from frozen, without thawing or proofing, to a baked specific volume of at least about 2.8 cubic centimeters per gram.

In yet another aspect, the invention relates to a frozen, unproofed dough composition that includes flour, water, yeast, basic chemical leavening agent, and acidic chemical leavening agent. The frozen dough composition has a raw specific volume in the range from than 1 to 1.3 cubic centimeters per gram, and the dough composition can be baked from frozen, without thawing or proofing, to a baked specific volume of at least about 2.8 cubic centimeters per gram.

### DETAILED DESCRIPTION

Dough compositions of the invention can be formed in any suitable manner consistent with the present description, such as by steps included in methods generally understood and referred to as sponge methods, straight-dough methods, or continuous dough methods. The particular formula for the dough will be dictated by the resulting end product. The dough composition can range anywhere from a bread to pastry, or otherwise.

Generally, dough compositions according to the invention can be prepared from ingredients known in the dough and bread-making arts, typically including flour, a liquid component such as oil or water, and optionally additional ingredients such as shortening, salt, sweeteners, dairy products, egg products, processing aids, emulsifiers, particulates, dough conditioners, flavorants, etc. Dough compositions of the invention also include a leavening system that contains both yeast and chemical leavening agents.

Chemical leavening agent can include any type or combination of agents useful to act as a chemical leavening agent. Generally preferred chemical leavening agents can include an acidic agent and a basic agent, the two of which react to produce carbon dioxide to leaven the dough composition.

Useful basic agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic agents are generally soluble in an aqueous component of a dough composition at processing conditions (e.g., at or about room temperature, e.g., from 50 F to 70 F).

The amount of a basic agent to be used in a dough composition of the invention is preferably sufficient (in combination with any action of the yeast) to react with the acidic agent to release a desired amount of gas for contributing to a desired raw specific volume achieved prior to freezing. A preferred raw specific volume for an unproofed freezer-to-oven dough composition according to the invention, prior to freezing, can be below 1.3 cubic centimeters per gram (cc/g), e.g., from 1 to 1.2 cc/g. The amount of a basic agent can additionally be sufficient to react with the acidic agent to release a desired amount of gas (in combination with any leavening action of the yeast) to contribute to a desired baked specific volume achieved by baking the dough composition from frozen storage (without thawing or proofing).

According to the invention, it has been found that the amount of chemical leavening agents, e.g., basic agent, does not need to be exceedingly high to achieve the raw specific volumes and baked specific volumes described herein for a freezer-to-oven dough composition. The use of ingredients that include both a chemical leavening system and yeast, and the method of using a rest step to achieve the described raw specific volume prior to freezing, as also described herein, can result in the desired baked specific volumes. Accordingly, the use of yeast, chemical leavening system, and the rest step, as described, allows the use of relatively low amounts of the chemical leavening agents. Dough compositions of the invention can achieve desired raw specific volumes (e.g., from 1 to 1.3 cc/g at freezing), and desired baked specific volumes of at least 2.8 cc/g, without any proofing step, with amounts of basic leavening agent below 2.5 Baker's percent, e.g., from 0.5 to 2.5 Baker's percent, preferably from about 0.5 or 1, up to about 2 Baker's percent.

Acidic chemical leavening agents are generally known in the dough and bread-making arts, with some examples including leavening phosphates such as SALP (sodium aluminum phosphate), SAPP (sodium acid pyrophosphate), monosodium phosphate, monocalcium phosphate monohydrate (MCP), anhydrous monocalcium phosphate (AMCP), and dicalcium phosphate dihydrate (DCPD); organic acids; glucono-delta-lactone; and others. Commercially available acidic agents can include those sold under the trade names: Levn-Lite® (SALP), Pan-O-Lite® (SALP+MCP), STABIL-9® (SALP+AMCP), PY-RAN® (AMCP), and HT® MCP (MCP).

Acidic chemical leavening agents include acidic agents that are relatively soluble (“fast-acting”) at processing conditions (e.g., at a temperature ranging from above freezing up to room temperature), as well as relatively insoluble (“slow-acting”) acidic agents at processing conditions. Those that are relatively soluble can dissolve at processing conditions and can thereby enter the dough composition to react with a dissolved basic chemical leavening agent to produce carbon dioxide, e.g., during a resting step. Those that are relatively less soluble or relatively insoluble at processing conditions do not dissolve to the same extent at processing conditions. By dissolving to a lesser extent at processing conditions, a slow-acting acidic leavening agent will produce less leavening gas during processing or resting, even though the acidic agent may still contribute some degree of leavening during processing. The slow-acting acidic agent will contribute to leavening upon dissolution of the agent, which occurs for the most part at higher temperatures such as temperatures experienced during baking.

Acidic agents that exhibit relatively high solubility at processing conditions include monocalcium phosphate monohydrate, glucono-delta-lactone (GDL), anhydrous monocalcium phosphate (AMCP), potassium acid tartrate, organic acids such as fumaric, ascorbic, citric, lactic, sorbic, and propionic, and other acidic agents that exhibit solubility behaviors similar to MCP, and GDL, or others. Acidic agents that exhibit relatively high solubility at processing conditions can become dissolved and react with a dissolved basic agent (e.g., a soluble, non-encapsulated basic agent) at processing conditions to produce carbon dioxide and contribute to an increased raw specific volume of a dough composition, prior to freezing and preferably during a rest step.

Dough compositions according to the invention may or may not include an amount of fast acting acidic agent. When used, a fast-acting acidic agent may be used in a way to prevent undue leavening prior to freezing, e.g., to avoid a raw specific volume greater than 1.3 cc/g at freezing. For example, a fast acting acidic agent may be encapsulated to achieve a desired raw specific volume prior to freezing. Alternatively, a fast acting acid may be used in combination with an encapsulated basic agent. A blend of fast acting and slow acting acidic agents may be used, e.g., in amounts that would include predominantly (e.g., a preponderance of) slow acting acidic agent with a lower amount of fast acting acidic agent. As discussed, the amount of reaction between acidic agent and basic agent prior to freezing desirably does not increase RSV to more than 1.3 cc/gram, so a lower amount of fast acting acidic agent may be generally preferred. Accordingly, fast acting acidic agent may be used in combination with an amount of a slow-acting acidic agent, with the amount of slow acting acidic agent being relatively greater than the amount of the fast acting acidic agent.

Acidic agents that exhibit relatively low solubility in dough compositions at processing conditions can also be referred to as “slow-acting” acidic agents. According to invention, slow-acting acidic agents can be preferred for preparing an unproofed freezer-to-oven dough composition that has a frozen raw specific volume in the range from 1 to 1.3 cc/gram, preferably from 1 to 1.2 cc/gram. These acidic agents can remain substantially undissolved (i.e., are insoluble) at processing conditions. Exemplary slow-acting acidic agents become soluble and dissolve within a dough composition at temperatures experienced during baking, and thereby become available to react with a basic active ingredient to leaven the dough composition. Acidic agents that can exhibit relatively low solubility at processing conditions include SALP and SAPP, dicalcium phosphate (DCP), dimagnesium phosphate (DMP), sodium aluminum sulfate (SAS), and chemical leavening agents that exhibit solubility behaviors that are similar to any of these, e.g., solubility behavior that is similar to SALP or SAPP.

Amounts of acidic agent included in a dough composition can be any amount sufficient to neutralize an amount of basic agent, for example an amount that is stoichiometric to the amount of basic agent, with the exact amount being dependent on the particular acidic agent that is chosen. The amount of acidic chemical leavening agent (and basic leavening agent) can also be selected based on factors such as the amount of yeast that is used. The amount of acidic agent to be used in a dough composition of the invention is preferably sufficient (in combination with any action of the yeast, and considering factors such as the solubility of the acidic agent or agents) to react with basic agent to release a desired amount of gas for contributing to a desired raw specific volume achieved prior to freezing. A preferred raw specific volume for an unproofed freezer-to-oven dough composition, prior to freezing, can be below 1.3 cubic centimeters per gram (cc/g), e.g., from 1 to 1.2 cc/g. The amount of acidic agent can also result in a dough composition that leavens to a desired baked specific volume, without a pre-proofing step prior to frozen storage and without a thawing or proofing step following frozen storage, such as a baked specific volume of at least 2.8 cubic centimeters per gram (cc/g), preferably at least 2.9 cc/g, more preferably from 3 to 4 cc/g.

As noted, it has been found that the amount of chemical leavening agents does not need to be exceedingly high to achieve the raw specific volumes and baked specific volumes described herein. The use of yeast, chemical leavening system, and the rest step, as described, allows the use of relatively low amounts of the chemical leavening agents. Exemplary dough compositions of the invention can achieve the desired raw specific volumes (e.g., below 1.3 cc/g), and baked specific volumes of at least 2.8 cc/g, by using amounts of sodium aluminum phosphate (SALP) on the order of slightly greater than 1 part by weight SALP per part by weight basic leavening agent, e.g., from 1.1 to 1.2 part by weight acidic acid (e.g., SALP) per part by weight basic leavening agent.

In certain embodiments of the invention, the acidic agent, the basic agent, or both, may be encapsulated, while still achieving desired raw specific volume prior to freezing and desired baked specific volume upon baking. In particular embodiments, an encapsulated basic chemical leavening agent may optionally be used in combination with fast-acting acidic chemical leavening agent to produce desired leavening activity of the chemical leavening agents during processing, to produce desired specific volumes prior to freezing and upon baking. Alternatively, a fast acting acidic agent may be encapsulated. Encapsulation of one or the other of a basic or acidic agent can inhibit reaction of the agents during mixing and processing of a dough composition prior to resting or freezing, to allow the agents to react at another time to produce a desired raw specific volume, e.g., during resting prior to freezing, and then to achieve a desired baked specific volume upon baking.

A number of encapsulated particles containing acidic agent or basic agent and an encapsulating material (e.g., barrier material) are known, and can be prepared by methods known in the baking and encapsulation arts. An example of a method for producing encapsulated particles is the use of a fluidized bed.

The inventive dough compositions also contain yeast in an amount to contribute to the baked specific volume of the dough composition. Again, according to the invention, the combined actions of yeast and a chemical leavening system—e.g., during a rest step prior to freezing, during baking, or both—will result in a dough composition having a desirable baked specific volume, e.g., a baked specific volume of at least 2.8 cc/g. Yeast can contribute to producing a desired specific volume of a dough composition by generating a gas (e.g., carbon dioxide) due to metabolic activity of the yeast. As used in the invention, yeast may contribute to increasing the raw specific volume of a dough composition prior to freezing, e.g., during a rest step. Alternatively or additionally, yeast may become active during early stages of baking to also contribute to increasing the specific volume of the dough during baking, to achieve a desired baked specific volume, e.g., of greater than 2.8 cc/g.

Yeast included in the inventive dough composition may be any type of suitable yeast that can leaven and preferably contribute to the desired raw specific volume and baked specific volumes described herein. Useful yeasts may include, for example, fresh crumbled yeast (also called cake yeast or compressed yeast), yeast cream, instant dry yeast, dry active yeast, protected active dry yeast, frozen yeast, and combinations of these.

Yeast ingredients such as these can differ in the amount of moisture contained in a yeast ingredient, which can in turn influence how much of a particular yeast ingredient should be combined with other ingredients to provide a dough composition according to the invention. This selection will be readily understood by those skilled in the dough and baking arts. For example, fresh crumbled yeast (and cake yeast and compressed yeast ingredients) has a higher moisture content than dry active yeast ingredient.

The moisture content of a yeast ingredient can affect the total amount of a yeast ingredient included in a dough composition. Fresh crumbled yeast, cake yeast, and compressed yeast have a moisture content of about 70% by weight of the yeast ingredient. Yeast cream typically has a higher moisture content, and dry active yeast typically has a lower moisture content, e.g., of about 8% by weight of the yeast ingredient. Thus, due to the difference in moisture content, a lower total amount of an overall dry active yeast ingredient (including less water) would likely be needed in place of a higher moisture content yeast ingredient such as fresh crumbled yeast, cake yeast, or compressed yeast. To be clear, the total amount of the yeast portion of the yeast ingredient that is added should be similar, but the amount of moisture included by adding each ingredient will differ, causing different total amounts of the ingredients to be used.

Exemplary amounts of yeast (e.g., compressed yeast or other forms of yeast) can preferably be an amount that is useful to contribute to a desired RSV prior to freezing (e.g., during a rest step as described herein). Relatively higher amounts of yeast (within a useful range) can be used to reduce the time required to achieve a desired raw specific volume prior to freezing, such as during a rest step, and if relatively lower amounts (within a useful range) are used, more time may be required. Specific exemplary amounts of compressed yeast may be in the range from 1 to 12 parts by weight compressed yeast per 100 parts by weight flour (i.e., from 1 to 12 Baker's percent), e.g., from 4 to 10 Baker's percent. Forms of yeast ingredients that are not compressed yeast, but that have similar moisture content to compressed yeast, can be used in these same ranges. Yeast ingredients that have different (higher or lower) percent moisture can be used in higher or lower amounts (respectively), but still in amounts that will provide the same or similar amount of the yeast component of the yeast ingredient, preferably to achieve raw specific volumes and baked specific volumes as described herein.

The invention combines yeast and chemical leavening agent to achieve a dough composition that exhibits very useful baked specific volume of a dough that is not pre-proofed prior to freezing and that can be baked from frozen to a very useful baked specific volume, e.g., greater than 2.8 cc/g, preferably greater than 2.9 cc/g, preferably in the range from 3 to 4 cc/g. The yeast, chemical leavening agents, or both, and the use of a rest step prior to freezing, may produce a raw specific volume in the range from 1 to 1.3 cc/g prior at freezing, e.g., a raw specific volume in the range from 1 to 1.2 cc/g, for an unproofed freezer-to-oven dough composition. The separate actions of the yeast and the chemical leavening agents may contribute differently prior to freezing and upon baking, to different degrees, depending on factors such as the amount of each type of leavening agent used and the types, especially the types of chemical leavening agents.

One exemplary embodiment of a dough composition of the invention, that can exhibit the desired raw specific volume prior to freezing (without proofing prior to freezing), and the desired baked specific volume when baked directly from frozen storage, may include an amount of basic leavening agent in the range from 0.5 to 2.5 Baker's percent (e.g., from about 0.5 to about 2 Bakers percent); an amount of acidic leavening agent (e.g., SALP) in the range from 0.5 to 3 Baker's percent (e.g., from 0.6 to 2.4 Baker's percent); and an amount of compressed yeast in the range from 4 to 10 Baker's percent.

Generally, dough compositions of the invention can include flour in an amount in a range of between about 30 wt % and about 70 wt % by weight of the dough, water in an amount of between about 30 wt % and about 40 wt % by weight of dough, sugar in an amount in a range of between 2 wt % and about 15 wt %. Other dry minor ingredients such as dough conditioners and salt may be present.

The flour component can be any suitable flour or combination of flours, including glutenous flour or a combination of glutenous and nonglutenous flours, and combinations thereof. The flour or flours can be whole grain flour, flour with the bran and/or germ removed, or combinations thereof. Unlike some other FTO dough compositions, the compositions of the invention do not require an increased protein concentration. The inventive dough compositions can be prepared to have a gluten content of no greater than 16 weight percent or preferably no more than 13 weight percent gluten, based on the total weight of flour (i.e., less than 16 or 13 parts by weight gluten per 100 parts by weight flour). Dough compositions can include these amounts of gluten without the need for high protein flour or concentrated gluten ingredients such as vital wheat gluten. Accordingly, a useful flour may include, e.g., from 11 to 13 percent protein, and no additional protein needs to be added in the form of a separate ingredient. Typical dough compositions can include between about 45% to about 60% by weight flour, such as from about 50 to 55 weight percent flour.

The dough composition can also include one or more liquid components. Examples of liquid components include water, milk, eggs, and oil, or any combination of these. Preferably, the liquid component includes water, e.g., in an amount in the range from about 15 to 35 weight percent, although amounts outside of this range may also be useful. Water may be added during processing in the form of ice, to control the dough temperature in process; the amount of any such water used is included in the amount of liquid components. The amount of liquid components included in any particular dough composition can depend on a variety of factors including the desired moisture content of the dough composition. Typically, liquids can be present in a dough composition in an amount between about 15% by weight and about 35% by weight, e.g., between about 20% by weight and about 30% by weight.

The dough composition can optionally include an egg product, e.g., for flavoring. Examples of egg products include fresh eggs, egg substitutes, dried egg products, frozen egg products, etc. The amount of egg products, if used, can be between about 0.1 percent by weight and about 35 percent by weight. The egg products may be in a dried form or a liquid form. If a liquid form of egg product is used, the amount of liquid component is adjusted to take into account the moisture content resulting from the liquid egg product.

The dough composition can optionally include dairy products such as milk, buttermilk, or other milk products, in either dried or liquid forms. Alternatively, milk substitutes such as soy milk may be used. If used, dairy products can be included as up to about 25 percent by weight of the dough composition, e.g., between about 1 percent and about 10 percent of the dough composition. If a dried dairy product is used, it is not considered to be a part of the liquid component identified above; if a liquid form of a dairy product is used, the amount of other liquid components, if any, can be adjusted accordingly.

The dough composition can optionally include fat ingredients such as oils and shortenings. Examples of suitable oils include soybean oil, corn oil, canola oil, sunflower oil, and other vegetable oils. Examples of suitable shortenings include animal fats and hydrogenated vegetable oils.

If included, the amount of fat can depend in large part on the particular type of dough composition being prepared, i.e., a bread, a bagel, or a donut, roll, or other pastry. Fat can typically be used in amounts less than about 20 percent by weight, often less than 10 percent by weight of a total weight of a dough composition. If liquid oils are used as a fat, the amount of other liquid components can be adjusted accordingly. One of ordinary skill will recognize that the chosen amounts and types of fats included can be adjusted depending on the desired texture of the dough product.

The dough composition can optionally include one or more sweeteners, either natural or artificial, liquid or dry. If a liquid sweetener is used, the amount of other liquid components can be adjusted accordingly. Examples of suitable dry sweeteners include lactose, sucrose, fructose, dextrose, maltose, corresponding sugar alcohols, and mixtures thereof. Examples of suitable liquid sweeteners include high fructose corn syrup, malt, and hydrolyzed corn syrup. Often, dough compositions include between about 2% by weight and about 15% by weight, e.g., form about 5% by weight to about 10% by weight sweetener.

The dough composition can further include additional flavorings, for example, salt, such as sodium chloride and/or potassium chloride; whey; malt; yeast extract; inactivated yeast; spices; vanilla; natural and artificial flavors; etc.; as is known in the dough product arts. The additional flavoring can typically be included in an amount in the range from about 0.1 weight percent to about 10 weight percent of the dough composition, e.g., from about 0.2 to about 5 weight percent of the dough composition.

The dough composition can optionally include particulates such as raisins, currants, fruit pieces, nuts, seeds, vegetable pieces, and the like, in suitable amounts.

As is known, dough compositions can also optionally include other additives, colorings, and processing aids such as emulsifiers include lecithin, mono- and diglycerides, polyglycerol esters, and the like, e.g., diacetylated tartaric esters of monoglyceride (DATEM) and sodium stearoyl-2-lactylate (SSL).

Conditioners, as are known in the dough products art, can be used to make the dough composition tougher, drier, and/or easier to manipulate. Examples of suitable conditioners can include azodicarbonamide, potassium sulfate, L-cysteine, sodium bisulfate and the like. If used, azodicarbonamide is preferably not present in an amount more than 45 parts per million.

To produce a dough product, a dough composition (raw) is first produced. This can be accomplished using at least some techniques or steps that are known in the dough and dough product arts, for example according to one or more of the following steps, not to the exclusion of other steps, and not necessarily in the recited order.

Yeast can be included in the dough composition as any useful form, e.g., fresh yeast (cream or compressed), or from a dried yeast that is re-hydrated. Any particular form of yeast may be used if acceptable, and a particular form may be selected for reasons such as convenience or cost.

To prepare a dried yeast leavening agent for use, an active yeast composition can be hydrated to form a yeast slurry that can be incorporated into the flour. This will be known and understood by a skilled artisan. In a yeast slurry, the yeast is typically substantially dispersed without any desirable lumps. The yeast slurry can be mixed, tumbled, or agitated in a suitable manner to prevent the yeast from settling to the bottom.

Generally, the flour and any other dry ingredients (e.g., optionally chemical leavening agents) can be combined with the fat component, if used, and then combined with a yeast slurry (if a dry yeast is used) or with a pre-hydrated yeast. All ingredients are generally mixed together using any of a variety of methods and/or addition orders as are known in the dough-making arts, to form a raw dough composition.

Mixing may be performed in commercially available and well-known equipment, for example a horizontal bar mixer with a cooling jacket (e.g., a 2500 lb. horizontal bar mixer from Oshikiri in Japan). The dough composition is generally mixed between about 5 minutes and about 15 minutes or until a proper consistency is achieved. The target temperature for the resulting dough composition is generally between about 50° F. and about 80° F. (this can be controlled at least in part by the use of ice).

According to methods of the invention, the dough composition, following mixing and prior to freezing, includes a resting step that allows bubbles to form in the dough composition, or to enlarge the size of bubbles in the dough composition after mixing, to form bubbles that improve baked specific volume upon baking. The bubbles can contribute to a desired increase in raw specific volume prior to freezing. The bubbles also act during baking to increase the specific volume of the dough during baking, preferably to a baked specific volume that is greater than the baked specific volume of an identical dough that is processed without the same resting step. In preferred embodiments of the invention, the dough can be rested directly after mixing to produce a dough that will achieve a higher baked specific volume than an identical dough processed the same way except without the rest step.

A dough composition immediately after mixing may normally have a raw specific volume of less than 1 cubic centimeter per gram (cc/g), generally about or below about 0.9 cc/g. A resting step according to the invention is practiced to allow the action of yeast, chemical leavening agent, or both, to produce gas, which produces or expands bubbles within the dough matrix and increases the raw specific volume of the dough composition.

As specific examples of a useful rest step, a rest step can take any amount of time to give a desired size of bubble and raw specific volume at freezing, and can preferably be performed for from about 5 to about 30 minutes, e.g., from about 10 to about 20 minutes. Longer times may also be used, but there may be no additional benefit after 20 or 30 minutes. Alternatively, the dough can be rested for an amount of time that achieves a desired raw specific volume upon freezing, e.g., a raw specific volume of less than 1.3 cc/g at freezing, e.g., a raw specific volume of from 1 to 1.2 cc/gram at freezing.

The resting step may be performed at any time between combining ingredients to produce a raw dough composition, and freezing. Preferred methods of the invention can include a rest step following mixing, and prior to forming a dough composition, followed then by freezing, the packaging the frozen dough composition.

Once the dough composition has been prepared, it can be further processed according to known methods of forming a dough composition into a desired size and shape (followed by other processing steps such as packaging, freezing, and cooking). A variety of techniques can be used for processing, as are known. For example, processing of the dough composition can include one or more of sheeting, extruding, dividing and rounding, and the like; cutting to a desired size and shape; folding; filling; and cooking. According to the invention, any processing can be useful, including any one or more of those identified directly above. Preferred processing techniques after resting can include sheeting, dividing and rounding, or any other technique that results in a rested, processed dough composition that exhibits a desired raw specific volume, and that preferably bakes to a baked specific volume that is greater than a baked specific volume of an identical dough composition that has not been processed to include a resting step.

A sheeted or divided and rounded dough composition can be assembled into any of a variety of shapes and products, as desired. Methods and equipment for shaping, sizing, or otherwise cutting sheeted dough compositions are well known. The size and shape of the product may depend on the type of dough product being prepared, as well as other factors such as the dough composition, e.g., whether it is light and/or sweet like a donut or heavy like a pretzel or bagel, whether or not it is intended to be heated (e.g., in a toaster), etc.

In one preferred embodiment of the invention, the dough product can be cut and rolled into the form of a cinnamon roll, which can be formed by cutting a strip of dough composition, adding cinnamon to a surface, and rolling from an end.

Methods of shaping and sizing a dough product, including steps of sheeting, cutting, folding, perforating, crimping, and otherwise assembling, are well known, and are described, for example, in Assignee's copending U.S. patent application Ser. No. 09/432,946, filed Nov. 3, 1999, incorporated herein by reference.

According to the invention, the dough composition is not processed to include a proofing step prior to freezing, but can be frozen at a desired raw specific volume, e.g., in the range from 1 to 1.3 cc/g, preferably a raw specific volume in the range from 1 to 1.2 cc/g.

Rested and processed, unproofed, dough pieces can be cooled and frozen (this can be done optionally either before or after other steps such as packaging) to a frozen storage temperature, and packaged in suitable packaging. For frozen distribution, i.e., a temperature of less than 32 F (0 C), the preferred storage temperature is in the range of between about −20 F and about 20 F preferably in a range of between about −10 F (−25 C) and about 10 F (−12 C). Storage temperature may vary throughout storage time. It is preferred that these temperatures be maintained for at least a majority and preferably at least about 90% of the time the product is stored.

The dough composition can be packaged by any desired methods and using any desired packaging materials. The packaging need not be air tight, but can preferably be closed to prevent water loss. Unlike other FTO dough compositions, the composition need not be packaged to maintain the dough composition in a modified atmosphere such as an atmosphere that includes an artificially high concentration of one or more of nitrogen or carbon-dioxide compared to ambient atmospheric air, although such modified atmosphere packaging can be used if desired.

The frozen dough compositions can be cooked as desired. Exemplary cooking temperatures can be in the range of between about 325 F (163 C) and about 400 F (205 C) for baking and is in the range of between about 350 F (175 C) and about 400 F (205 C) for frying. The dough can be baked in any type of oven, such as conventional, convection, or impingement ovens.

Microwaving would also be a way of baking the dough composition. The product will perform well in terms of volume expansion in a microwave, and a “browning” solution could be applied to cause the surface to brown.

The baked dough compositions of preferred embodiments of the invention, e.g., including a resting step, can exhibit improved baked specific volume relative to dough compositions prepared without a resting step as described. Exemplary baked specific volumes (BSVs) of a baked dough composition can be in the range from about 2.8 (cc/g) to at least 4 or more, preferably from about 3 to about 4 (cc/g).

The invention can be applied to a broad range of dough products, ranging from sweet rolls to bread doughs to any other yeast-leavened finished dough products such as breads (pan bread, baguettes, dinner rolls), pizza crust, and sweet rolls, and other dough products.

### EXAMPLES

| | Formula | | | | | |
|---|---|---|---|---|---|---|
| | A | B | C | D | E | F |
| | (%) | (%) | (%) | (%) | (%) | (%) |
| flour | 52.32 | 51.59 | 52.91 | 56.01 | 58.24 | 51.32 |
| water | 25.64 | 24.02 | 23.60 | 21.45 | 20.17 | 23.64 |
| Non-fat dry milk | 2.00 | 2.00 | 2.00 | 2.00 | 2.00 | 2.00 |
| dough conditioner | 0.39 | 0.39 | 0.39 | 0.39 | 0.39 | 0.39 |
| sucrose | 6.00 | 7.00 | 5.00 | 3.50 | 2.00 | 6.00 |
| shortening | 6.00 | 6.00 | 6.00 | 6.00 | 6.00 | 6.00 |
| eggs | 5.00 | 5.00 | 5.00 | 5.00 | 5.00 | 5.00 |
| salt | 1.00 | 1.00 | 1.00 | 1.00 | 1.00 | 1.00 |
| compressed yeast | 0.00 | 3.00 | 3.00 | 3.00 | 3.00 | 3.00 |
| sodium aluminum | | | | | | |
| phosphate (SALP) | 0.90 | 0.00 | 0.60 | 0.90 | 1.20 | 0.90 |
| sodium bicarbonate | 0.75 | 0.00 | 0.50 | 0.75 | 1.00 | 0.75 |

| | | rest step | yeast | soda/SALP | RSV | BSV |
|---|---|---|---|---|---|---|
| Example # | Formula | (min) | (%) | (%) | (cc/g) | (cc/g) |
| 1 | A | 0 | 0 | 0.75/0.90 | 1.09 | 2.41 |
| 2 | A | 20 | 0 | 0.75/0.90 | 1.07 | 2.31 |
| 3 | F | 0 | 3 | 0.75/0.90 | 1.16 | 2.57 |
| 4 | F | 20 | 3 | 0.75/0.90 | 1.21 | 3.13 |
| 5 | F | 40 | 3 | 0.75/0.90 | 1.12 | 3.09 |
| 6 | B | 20 | 3 | 0/0 | 1.04 | 2.07 |
| 7 | C | 20 | 3 | 0.50/0.60 | 1.04 | 2.94 |
| 8 | D | 20 | 3 | 0.75/0.90 | 1.10 | 3.13 |
| 9 | E | 20 | 3 | 1.00/1.20 | 1.10 | 3.33 |

1. A method of preparing a dough composition, the method comprising
providing a dough composition comprising flour, water, chemical leavening agent, and yeast as a leavening agent,
resting the dough composition for a period sufficient to improve the baked specific volume of the dough composition upon baking, and
freezing the dough composition without proofing,
wherein the dough composition can be baked from frozen, without thawing or proofing, to a baked specific volume of at least about 2.8 cubic centimeters per gram.

2. The method of claim 1 comprising freezing the dough composition while the dough composition has a raw specific volume in the range from about 1 to about 1.3 cubic centimeters per gram.

3. The method of claim 1 comprising
mixing dough ingredients comprising flour, water, yeast, and chemical leavening agent, to produce a dough composition,
resting the mixed dough composition for an amount of time sufficient for the dough composition to reach a raw specific volume in the range from about 1 to about 1.2,
processing the rested dough composition to form a dough piece, and
freezing the rested dough composition while at a raw specific volume in the range from about 1 to about 1.2.

4. The method of claim 1 wherein the dough composition is rested for a time in the range from about 10 to about 30 minutes.

5. The method of claim 4 comprising
processing the rested dough composition to form a dough piece, and
freezing the dough piece without proofing, while the dough piece is at a raw specific volume in the range from about 1 to about 1.3.

6. The method of claim 5 comprising
processing dough composition to form a cinnamon roll, and
baking the cinnamon roll to a baked specific volume of at least 3 cubic centimeters per gram.

7. The method of claim 1 comprising baking the frozen dough composition, without thawing or proofing the dough composition, to a baked specific volume of at least about 3 cubic centimeters per gram.

8. The method of claim 7 wherein the baked dough composition has a baked specific volume in the range from 3 to 4 cubic centimeters per gram.

9. The method of claim 1 wherein the dough composition comprises less than 2.5 parts by weight basic chemical leavening agent based on 100 parts by weight flour.

10. The method of claim 9 wherein the dough composition comprises from about 0.5 to about 2 parts by weight basic chemical leavening agent based on 100 parts by weight flour.

11. The method of claim 1 wherein the dough composition comprises from about 0.5 to about 2 parts by weight basic chemical leavening agent based on 100 parts by weight flour, the method comprising
resting the dough composition for a time in the range from about 10 to about 30 minutes,
freezing the rested dough composition without proofing, while the dough composition is at a raw specific volume in the range from about 1 to about 1.3, and
baking the dough composition to a baked specific volume in the range from 3 to 4 cubic centimeters per gram.

12. A method of preparing a dough composition, the method comprising
mixing ingredients into a dough composition, comprising flour, yeast, water, acidic chemical leavening agent, and less than 2.5 parts by weight basic chemical leavening agent based in 100 parts by weight flour,
resting the dough composition for at least five minutes,
freezing the dough composition without a proofing step,
storing the frozen dough composition, and
baking the frozen dough composition, without thawing or proofing, to a baked specific volume of at least about 2.8 cubic centimeters per gram.

13. The method of claim 12 comprising baking the frozen dough composition to a baked specific volume of at least 3 cubic centimeters per gram.

14. A method of preparing a dough composition, the method comprising
mixing ingredients into a dough composition, comprising flour, yeast, water, acidic chemical leavening agent, and basic chemical leavening agent,
resting the dough composition to produce a raw specific volume in the range from about 1.0 to about 1.3 cubic centimeters per gram,
freezing the dough composition having a raw specific volume of from 1.0 to 1.3 cubic centimeters per gram, and
baking the frozen dough composition, without thawing or proofing, to a baked specific volume of at least about 2.8 cubic centimeters per gram.

15. The method of claim 14 comprising baking the frozen dough composition to a baked specific volume of at least 3 cubic centimeters per gram.

16. A frozen, unproofed dough composition comprising
flour,
water,
yeast,
chemical leavening agent comprising greater than zero and less than 2.5 parts by weight basic chemical leavening agent, based on 100 parts by weight flour, and
acidic chemical leavening agent;
wherein the dough composition can be baked from frozen, without thawing or proofing, to a baked specific volume of at least about 2.8 cubic centimeters per gram.

17. The dough composition of claim 16 comprising from about 0.5 to about 2 parts by weight basic chemical leavening agent based on 100 parts by weight flour.

18. The dough composition of claim 16 wherein the frozen dough composition has a raw specific volume in the range from about 1.0 to about 1.3 cubic centimeters per gram.

19. The dough composition of claim 16 wherein the dough composition can be baked to a baked specific volume in the range from about 3 to about 4 cubic centimeters per gram.

20. A frozen, unproofed dough composition comprising
flour, water, yeast, basic chemical leavening agent, and acidic chemical leavening agent;
the frozen dough composition having a raw specific volume in the range from than 1 to 1.3 cubic centimeters per gram,
wherein the dough composition can be baked from frozen, without thawing or proofing, to a baked specific volume of at least about 2.8 cubic centimeters per gram.
